(19) United States
(12) Patent Application Publication
(10) Pub. No.: US 2008/0094667 A1
(43) Pub. Date: Apr. 24, 2008

(54) Communication apparatus

(76) Inventor: Itaru Kodaira, Kanagawa (JP)

Correspondence Address: COOPER & DUNHAM, LLP, 1185 AVENUE OF THE AMERICAS, NEW YORK, NY, 10036, US

(21) Appl. No.: 11/973,783

(22) Filed: Oct. 10, 2007

(30) Foreign Application Priority Data
Oct. 19, 2006 (JP) 2006-285330

(51) Int. Cl. H04N 1/32

(52) U.S. Cl. 358/442

(57) ABSTRACT

A communication apparatus includes a specifying unit, a display unit, a communication control unit, and a communicating unit. The specifying unit specifies a communication destination. The display unit displays information on the communication destination on a check screen. The communication control unit issues an instruction to initiate communication with the communication destination after the information is checked on the check screen. The communicating unit communicates with the communication destination in response to the instruction from the communication control unit.

### CROSS-REFERENCE TO RELATED APPLICATIONS

The present application claims priority to and incorporates by reference the entire contents of Japanese priority document, 2006-285330 filed in Japan on Oct. 19, 2006.

### BACKGROUND OF THE INVENTION

1. Field of the Invention

The present invention relates to communication apparatuses.

2. Description of the Related Art

Recent facsimile machines, allow a user to specify a plurality of destinations, such as multifunction products (MFP), other facsimile machines, and any terminals having email function, and is capable of transmitting the same document to the destinations with one operation. For example, Japanese Patent Application Laid-Open No. 6-105015 discloses a conventional facsimile machine for improving operation efficiency of a one-touch dial key at the time of transmission to a plurality of destinations.

However, in recent times, information leakage due to transmission to an erroneously-specified destination has been a problem, and thus it is necessary to check before transmission whether the specified destination is wrong. In particular, when a plurality of destinations are specified, checking whether these destinations are wrong is burdensome, and therefore people tend to transmit without checking these destinations. For example, Japanese Patent Application Laid-Open No. 11-234458 discloses another conventional facsimile machine that makes a request for checking the destinations at the time of transmission to prevent transmission to a wrong destination.

In the former conventional facsimile machine, an easy scheme of specifying a plurality of destinations is disclosed, but the details of the specified destinations are not particularly checked. In the latter conventional facsimile machine, a destination-checking and transmitting process is performed according to the setting of a destination-checking-function ON/OFF switch. However, this destination-checking and transmitting process has a problem such that this process does not allow all destinations specified to be reliably checked, and therefore a reliable check of the specified destinations is not ensured.

### SUMMARY OF THE INVENTION

It is an object of the present invention to at least partially solve the problems in the conventional technology.

According to an aspect of the present invention, a communication apparatus includes a specifying unit that specifies a communication destination; a display unit that displays information on the communication destination on a first check screen; a communication control unit that issues an instruction to initiate communication with the communication destination after the information is checked on the check screen; and a communicating unit that communicates with the communication destination in response to the instruction from the communication control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a communication apparatus according to an embodiment of the present invention;

FIG. 2 is an example of an display unit shown in FIG. 1 ;

FIGS. 3 to 7 are schematic diagram for explaining transition of display on a display panel shown in FIG. 2;

FIGS. 8A to 8D are flowcharts of a process of specifying a destination performed by the communication apparatus;

FIG. 9 is another schematic diagram for explaining transition of display on the display panel;

FIGS. 10A to 10C are flowcharts of a process of specifying a destination performed by the communication apparatus;

FIG. 11 is another schematic diagram for explaining transition of display on the display panel;

FIGS. 12A to 12D are flowcharts of a process of specifying a destination performed by the communication apparatus;

FIG. 13 is another schematic diagram for explaining transition of display on the display panel;

FIG. 14A is a flowchart of a process of specifying a destination performed by the communication apparatus;

FIG. 14B is an example of contents of a transmitted destination list;

FIG. 15 is a flowchart of a process of specifying a destination performed by the communication apparatus;

FIG. 16 is another schematic diagram for explaining transition of display on the display panel;

FIG. 17A is a flowchart of a process of specifying a destination performed by the communication apparatus;

FIG. 17B is an example of contents of a user management table;

FIG. 18A is a flowchart of a process of specifying a destination performed by the communication apparatus; and

FIG. 18B is another example of contents of the transmitted destination list.

### DETAILED DESCRIPTION OF THE PREFERRED EMBODIMENTS

Exemplary embodiments of the present invention are explained in detail below with reference to the accompanying drawings.

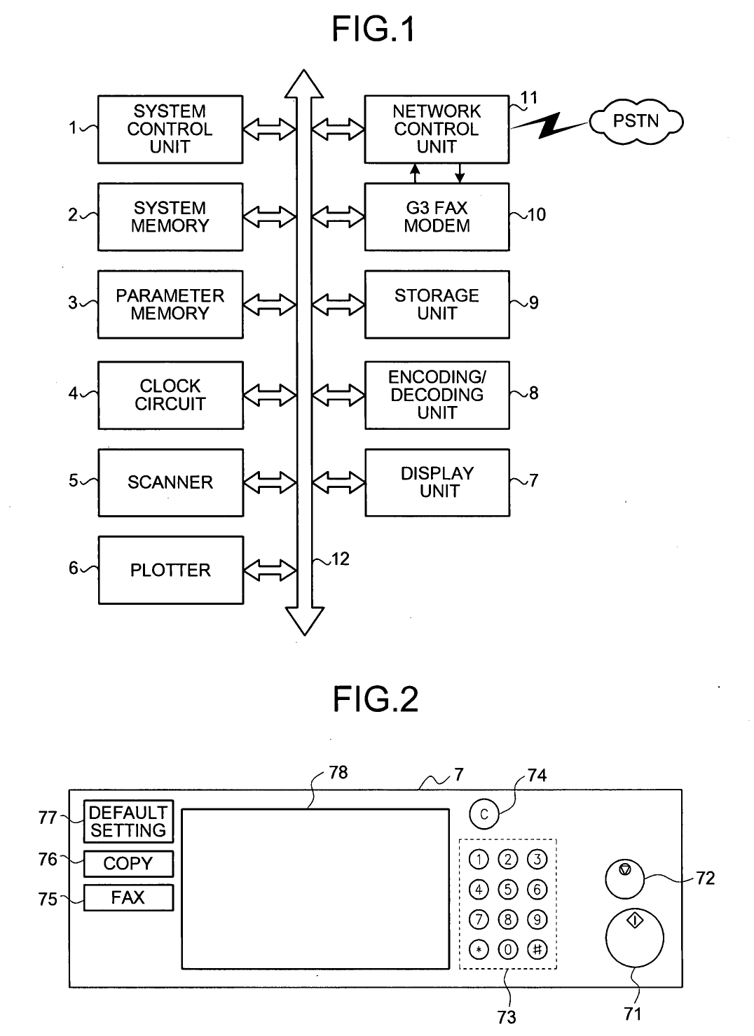

FIG. 1 is a schematic diagram of an MFP as a communication apparatus according to an embodiment of the present invention. The MFP has a G3 facsimile function for performing G3 facsimile communication and a copying function for printing out a duplication target. The MFP includes a system control unit 1, a system memory 2, a parameter memory 3, a clock circuit 4, a scanner 5, a plotter 6, a display unit 7, an encoding/decoding unit 8, a storage unit 9, a G3 facsimile modem 10, a network control unit 11, which are connected one another via an internal bus 12.

The system control unit 1 controls the MFP, G3 facsimile transmission, and copying operation. The system memory 2 stores therein a computer program to be executed by the system control unit 1 as well as various types of data required for executing the computer program, and provides a work area for the system control unit 1. The parameter memory 3 stores therein various types of information unique to the MFP. The clock circuit 4 is to output current-time information.

The scanner 5 is to read a document image with a predetermined resolution. The plotter 6 is to record and output the image with a predetermined resolution. The display unit 7 includes a display screen and various operation keys or buttons, and receives input from a user to operate the MFP.

The encoding/decoding unit 8 is to encode and compress an image signal and also decode the encoded and compressed image information to the original image signal. The storage unit 9 stores therein image information in a encoded and compressed state. The G3 facsimile modem 10 is to achieve a modem function of a G3 facsimile, including a low-speed modem function (V.21 modem) for exchanging a transmission procedure signal and a high-speed modem function (e.g., V.17 modem, V.34 modem, V.29 modem, V.27 ter modem) for mainly exchanging image information. The network control unit 11 is to connect the MFP to an analog public network such as public switched telephone network (PSTN), including an automatic incoming and outgoing function.

Data exchange among these components is performed mainly via this internal bus 12. Data exchange between the network control unit 11 and the G3 facsimile modem 10 is directly performed.

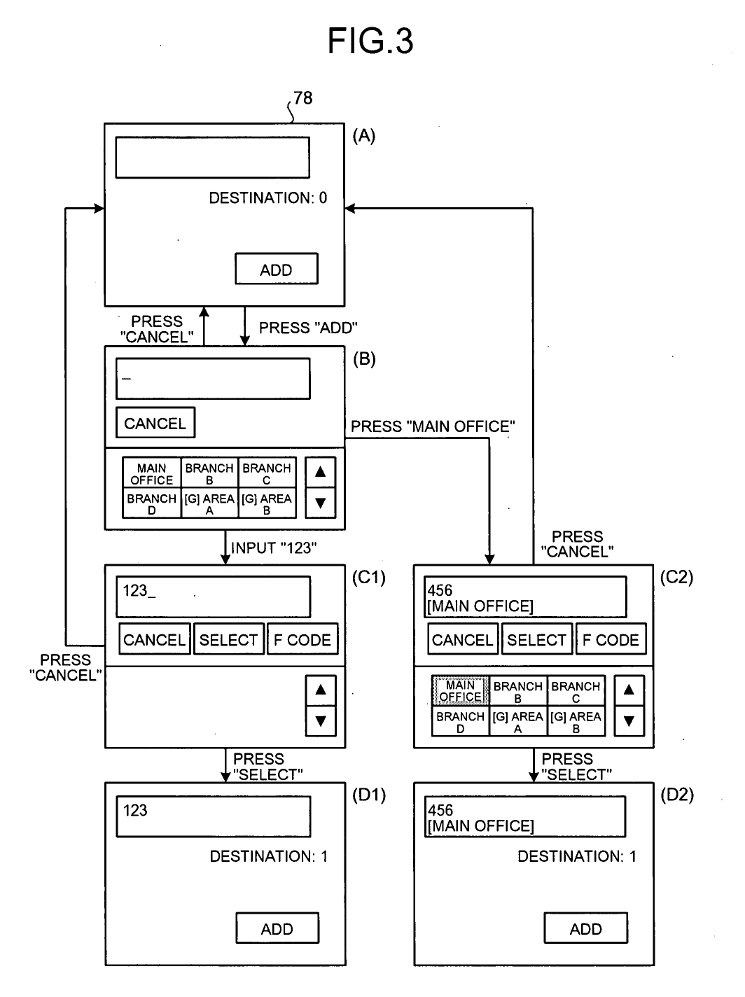

FIG. 2 is a schematic diagram of an example of the display unit 7. The display unit 7 includes a Start key 71, a Stop key 72, a numeric keypad 73, a Clear key 74, a FAX key 75, a Copy key 76, a Default Setting key 77, a display panel 78.

The Start key 71 is pressed to start instruction execution, such as transmission, on the MFP. Upon pressing of the Start key 71, a document reading and communication is started. The Stop key 72 is to input an instruction for stopping the operation of the MFP. The numeric keypad 73 is to input numeric (numeric-value) information, such as a telephone number. The Clear key 74 is to delete the telephone number or the like entered through the numeric keypad 73.

The FAX key 75 is pressed to set the MFP to facsimile mode. The Copy key 76 is pressed to set the MFP to copy mode. The Default Setting key 77 is pressed to set the MFP to default setting mode.

The display panel 78, such as liquid crystal display (LCD) panel, displays various types of information, such as an operation guidance of the MFP and feedback of input information. The display panel 78 also serves as a touch panel having a touchable surface that receives and processes user touches, i.e., touch input. A user provides. input by touching an item displayed on the display panel 78. Upon receiving touch input from a user, the display panel 78 detects coordinates of a position touched by the user, etc., and notifies the system control unit 1 of the results.

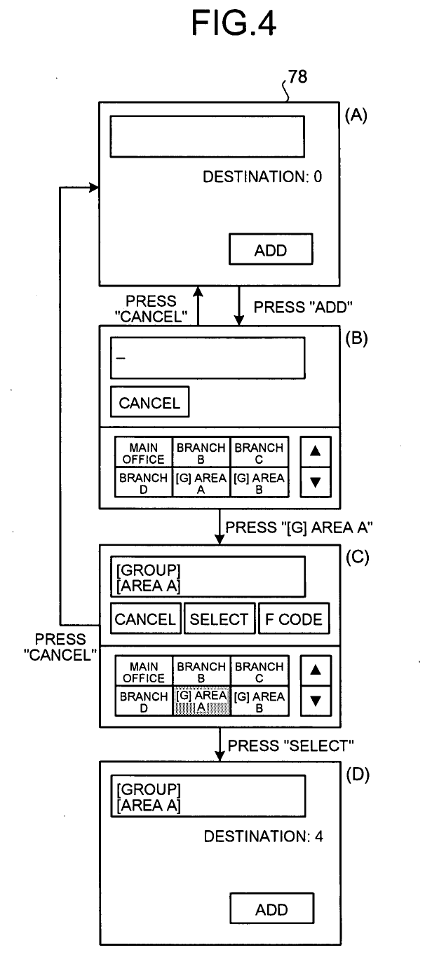

FIG. 3 is a schematic diagram for explaining transition of display on the display panel 78 for specifying a destination.

In FIG. 3, a screen (A) displays no destination, i.e., no destination has been specified by a user. At this time, when a user presses an “Add” key (touches an area “Add”) on the screen (A), the display panel 78 displays an input screen (B). On the input screen (B), a cursor is displayed in a frame (hereinafter, “destination frame”) indicated by the solid-bold line in the upper-left of the input screen (B). When the user enters a telephone number through the numeric keypad 73, the telephone number is displayed as shown in a screen (C1). The screen (C1) also displays “Select” and “F Code” keys, which are not displayed when no telephone number is entered or no destination in a directory is specified.

If destinations are registered in advance in the directory, the input screen (B) displays keys corresponding to the destinations (Main Office, etc.). When the user presses any one of the keys, a telephone number (in FIG. 3, “456”) and a destination name (in FIG. 3, Main Office) corresponding to the key are displayed as shown on a screen (C2). The screen (C2) also displays “Select” and “F Code” keys, and the key (Main Office) in a highlighted manner.

When the user presses the “Select” key on the screen (C1) or (C2), the destination is specified, and the display panel 78 displays a screen (D1) or (D2) showing the destination. When the user selects the destination from the directory, the destination name (Main Office) is displayed with the telephone number as shown on the screen (D2).

FIG. 3 is a schematic diagram for explaining transition of display on the display panel 78 for specifying a group of destinations.

A group of destinations (hereinafter, “destination group”) can be registered in the directory. When a destination group “area A” including four destinations: “Main Office”, “branch B”, “branch C”, and “branch D” are specified, the four destinations can be specified with one operation. This facilitates the operation of specifying a plurality of destinations.

Similarly to the operation of specifying a destination in the directory, when the user presses a key “[G] area A” ([G] represents a destination group) on a screen (B) of FIG. 4, “area A” is specified as a destination group as shown on a screen (C). After the user presses the “Select” key, the number of destinations increases by the number of destinations in the destination group (in FIG. 4, four) as shown on a screen (D).

FIG. 5 is a schematic diagram for explaining transition of display on the display panel 78 for specifying an F code.

An F code can be used as additional information for the destination at the time of facsimile transmission. Types of the F code include subaddress (SUB), sender identification (SID), selective polling (SEP), and password (PWD). By using the F code, functions, such as confidential transmission, can be achieved.

The “F Code” key appears when the user enters a destination as shown,on a screen (A) of FIG. 5. Then, when the user presses the “F Code” key, the display panel 78 displays an F-code input screen (B). In FIG. 5, the F-code input screen (B) displays a “SUB” key in a highlighted manner. This indicates that SUB can be entered from the numeric keypad 73. When the user presses another key, such as a “SEP” key, an F code “SEP” can be entered. When the user presses the “Select” key after entering an F code on a screen (C), F-code input for the destination is completed as shown on a screen (D). In the screen (D) and also a screen (E), “SUB” is displayed within the destination frame to indicate that the destination has a subaddress.

FIG. 6 is a schematic diagram of for explaining an example of transition of display on the display panel 78. When the user presses the Start key on the original screen (the screen with a destination already entered), the display panel 78 displays a destination-check screen (A) before transmission (reading, communication, etc.) of data. Once the user presses an “OK” key on the destination-check screen (A), the MFP starts transmission. With this, the user can check the destination before the MFP performs document reading and communication.

FIG. 7 is a schematic diagram for explaining another example of transition of display on the display panel 78. It is herein assumed that a number, twenty digits at maximum, can be displayed on the destination-check screen and the destination number is “01234567890123” (twenty-four digit number). When first opened, a screen (A) of FIG. 7 displays the upper twenty digits of twenty-four digits. The screen (A) also displays a “→” key to display lower four digits currently not displayed. When the “→” key is pressed once, the number is shifted by one digit rearward (to the right in FIG. 7) as shown on a screen (B). When the “→” key is pressed four times, the number can be displayed to the last digit as shown on a screen (C). With this, all digits of the destination number can be checked, and an “OK” key is displayed as shown on a screen (C). After checking the destination number, the user presses the “OK” key for start of document reading and communication.

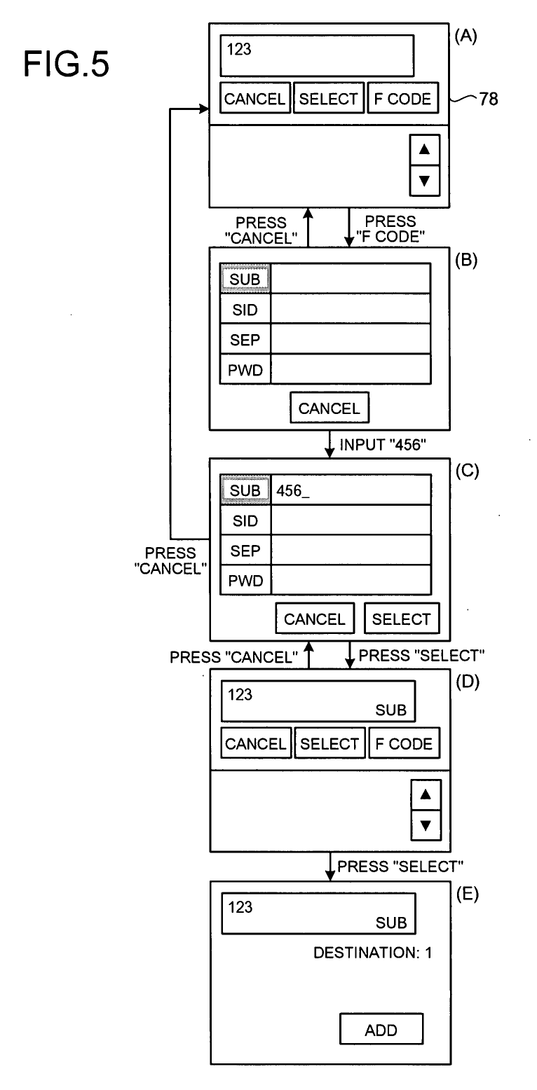

FIGS. 8A to 8D are flowcharts of the process of specifying a destination performed by the MFP. FIG. 8A depicts an initial process performed when the destination-check screen is first opened. FIG. 8B depicts a process performed when a “←” key is pressed. FIG. 8C depicts a process performed when the “→” key is pressed. FIG. 8D is a detailed flowchart of a display-update process shown in 8A to 8C. In FIGS. 8A to 8D, “V” represents the number of digits that can be displayed on the destination-check screen, “n” represents the number of digits of a destination number, “p” represents a position or a digit from which the number is displayed (hereinafter, “display-start position”), and “ok_flag” represents whether transmission can be started.

As shown in FIG. 8A, the display-start position p is initialized (step SA801). Next, if the number of digits n is equal to or less than the number of digits V (Yes at step SA802), all digits of the destination number can be displayed on the default screen, and therefore, “ok_flag=TRUE” is set, i.e., “ok_flag” represents that transmission can be started (step SA803). Otherwise (No at step SA802), not all digits are displayed on the default screen, and therefore, “ok_flag=FALSE” is set, i.e., “ok_flag” represents that transmission cannot be started (step SA804). Then, a display-update process is performed (step SA805).

As shown in FIGS. 8B and 8C, when the “←” or “→” key is pressed, the display-start position p is decremented by 1 to shift it to the front (left) (step SB801), or is incremented by 1 to shift it to the rear (right) (step SC801). After step SB801, the display-update process is performed (step SB802). In FIG. 8C, when the display-start position p is shifted such that the destination number is displayed up to the last digit, i.e., p=n−V (Yes at step SC802), “ok_flag=TRUE” is set (step SC803), and the display-update process is performed (step SA804).

As shown in FIG. 8D, in the display-update process shown in FIG. 8A, based on whether “ok_flag=TRUE” is set (step SD801), the “OK” key is displayed or not displayed (steps SD802 and SD804) with a corresponding message (steps SD803 and SD805). In the display-update process shown in FIGS. 8B and 8C, based on the display-start position p (steps SD806 and SD809), the “←” key or the “→” key is displayed (steps SD807, SD808, SD810, and SD811). Then, the destination number is displayed with V digits at maximum from the display-start position p (step SD812).

With this, even when a destination number contains many digits all of which cannot be displayed on a screen, all digits can be checked by key operation. Also, document reading and communication are prevented from being started until a user checks all digits.

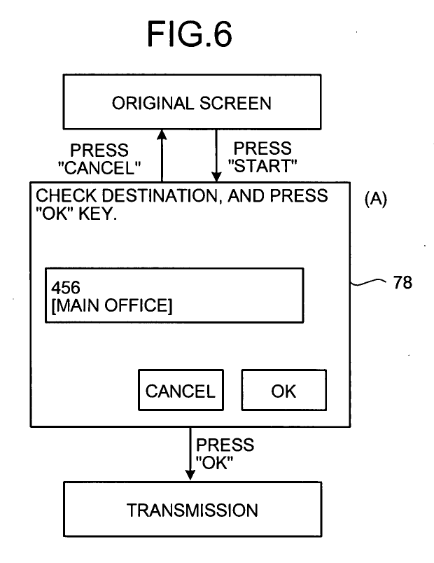

FIG. 9 is a schematic diagram for explaining yet another example of transition of display on the display panel 78. When the user has entered an F code with the destination, the display panel 78 displays the “F Code” key as shown on a screen (A) of FIG. 9. At this point, the screen (A) does not display the “OK” key. When the user presses the “F Code” key, the display panel 78 displays an F-code check screen (B). After the user checks the F code and presses a “Select” key on the F-code check screen (B), the display panel 78 displays a screen (C) displaying the “OK” key, so that the user can pressed it, i.e., transmission can be started.

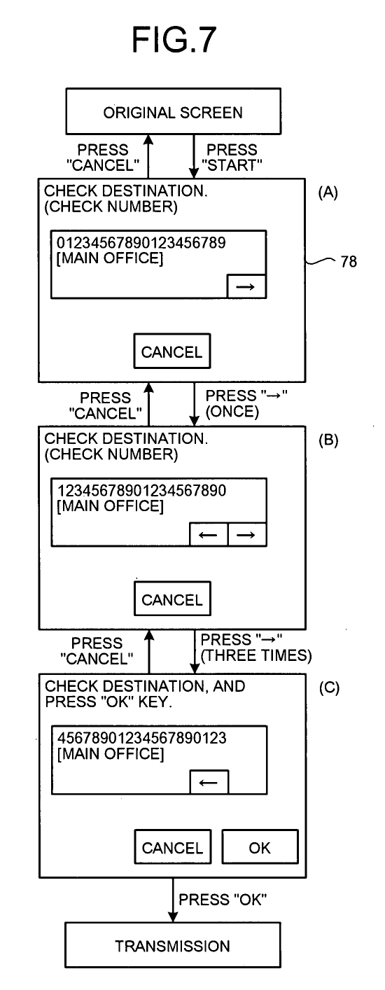

FIGS. 10A to 10C are flowcharts of the process of specifying a destination performed by the MFP. FIG. 10A depicts another initial process performed when the destination-check screen is first opened. FIG. 10B depicts a process performed when the “Check” key is pressed on the F-code check screen. FIG. 10C is a detailed flowchart of a display-update process shown in 10A and 10B. In FIGS. 10A to 10C, “ok_flag” represents whether transmission can be started.

As shown in FIG. 10A, after the display-start position p is initialized (step SA1001), if the destination includes an F code (Yes at step SA1002), “ok_flag=FALSE” is set (step SA1003), and the “F-code” key is displayed (step SA1004). On the other hand, if the destination does not include an F code (No at step SA1002), “ok_flag=TRUE” is set (step SA1005). In this case, the “F-code” key is not displayed (step SA1006). Then, the display-update process is performed (step SA1007).

As shown in FIG. 10B, when the “Check” key is pressed on the F-code check screen, “ok_flag=TRUE” is set (step SB1001), and the F-code check screen is closed (step SB1002). Then, the display-update process is performed (step SB1003).

As shown in FIG. 10C, based on whether “ok_flag=TRUE” is set (step SC1001), the “OK” key is displayed or not displayed (steps SC1002 and SC1004) with a corresponding message (steps SC1003 and SC1005).

With this, when an F code is specified for a destination, the F code can also be checked on the destination-check screen. Also, document reading and communication are prevented from being started until a user checks the F code.

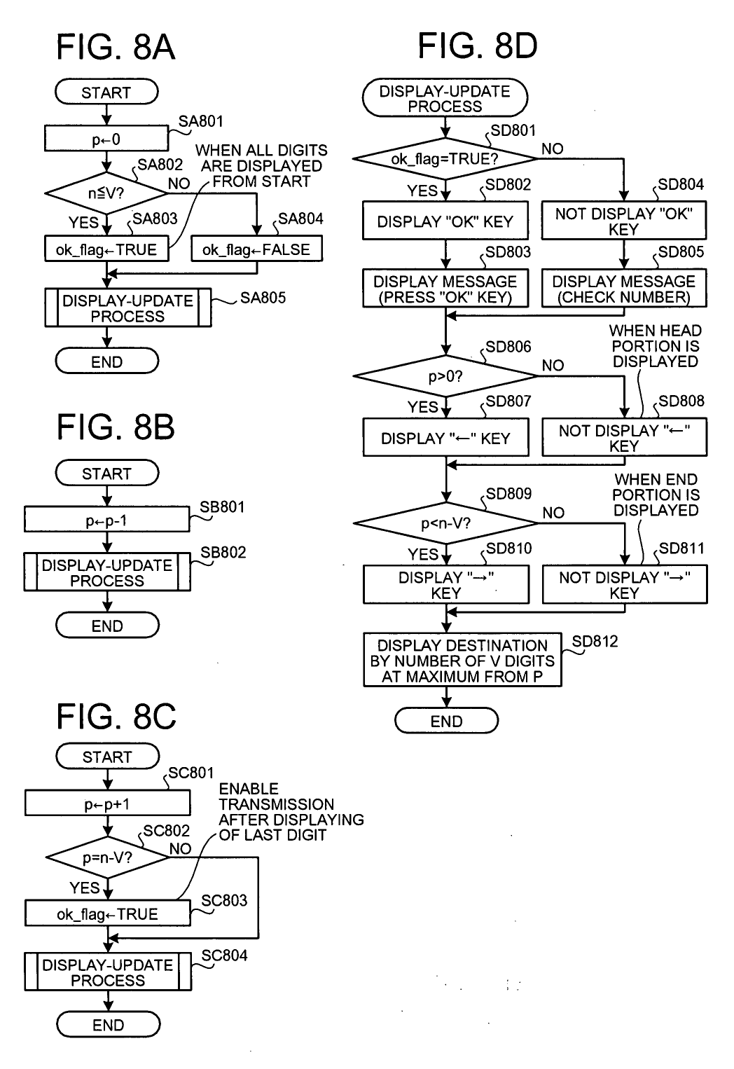

FIG. 11 is a schematic diagram for explaining yet another example of transition of display on the display panel 78. It is assumed herein that three destinations are specified.

When the destination-check screen is first opened as shown on a screen (A) of FIG. 11, the display panel 78 displays the first destination. When the user presses a “▾” key once on the screen (A), the display panel 78 displays the second destination as shown on a screen (B). When the “▾” is further pressed, two times in total, the display panel 78 displays the third, i.e., the last, destination as shown on a screen (C). While the screens (A) and (B) do not display the “OK” key, the screen (C), which is displayed after all destinations are checked, displays the “OK” key to allow transmission to be started.

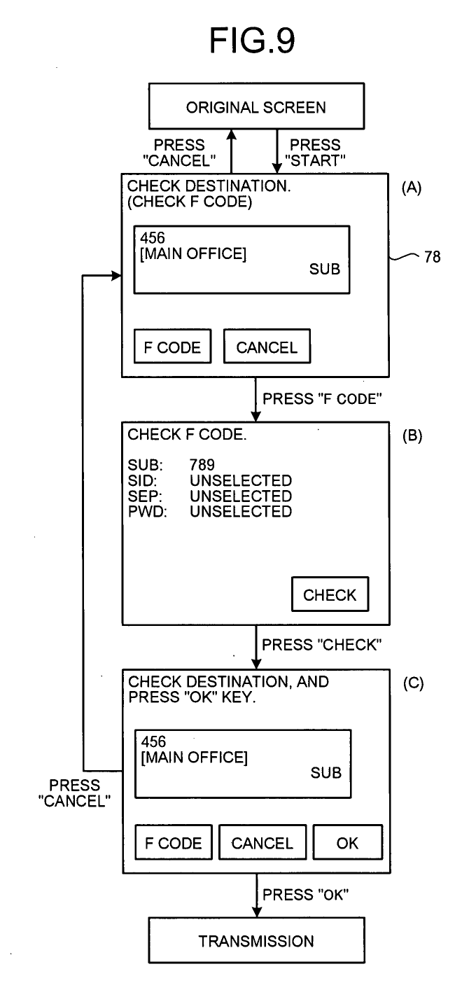

FIGS. 12A to 12D are flowcharts of the process of specifying a destination performed by the MFP. FIG. 12A depicts another initial process performed when the destination-check screen is first opened. FIG. 12B depicts a process performed when a “▴” key is pressed. FIG. 12C depicts a process performed when the “▾” key is pressed. FIG. 12D is a detailed flowchart of a display-update process shown in 12A to 12C. In FIGS. 12A to 12D, “ln” represents the number of destinations displayed on the destination-check screen, “conf_list[0] to conf_list[ln−1]” represents destinations displayed on the destination-check screen, “lp” represents a list position of the destinations displayed (0 to ln−1), and “ok_flag” represents whether transmission can be started.

In “conf_list”, each destination to be displayed on the destination-check screen is set; specified destinations may be sequentially set. As shown in FIG. 12A, after the list position lp is initialized (step SA1201), if the number of destinations displayed is 1 (Yes at step SA1202), all destination is displayed on the first screen. Thus, “ok_flag=TRUE” is set (step SA1203). Otherwise (No at step SA1202), not all destinations are displayed on the first screen, and “ok_flag=FALSE” is set (step SA1204). Then, the display-update process is performed (step SA1205).

As shown in FIGS. 12B and 12C, when “▾” or “▾” key is pressed, the list position lp is decremented by 1 to shift it to the front (step SB1201), or is incremented by 1 to shift it to the rear (step SC1201). After step SB1201, the display-update process is performed (step SB1202). In FIG. 12C, when “▾” is pressed” such that the destinations up to the last one (lp=ln−1) are displayed (Yes at step SC1202), “ok_flag=TRUE” is set (step SC1203), and the display-update process is performed (step SA1204).

As shown in FIG. 12D, in the display-update process shown in FIG. 12A, based on whether “ok_flag=TRUE” is set (step SD1201), the “OK” key is displayed or not displayed (steps SD1202 and SD1204) with a corresponding message (steps SD1203 and SD1205). In the display-update process shown in FIGS. 12B and 12C, based on the list position lp (steps SD1206 and SD1209), the “▴” key or the “▾” key is displayed (steps SD1207, SD1208, SD1210, and SD1211). Then, the destination indicated by “conf_list [lp]” is displayed (step SD1212)

With this, even when a plurality of destinations have been specified, all the destinations can be checked by pressing “▾” key. Also, document reading and communication are prevented from being started until a user checks all destinations.

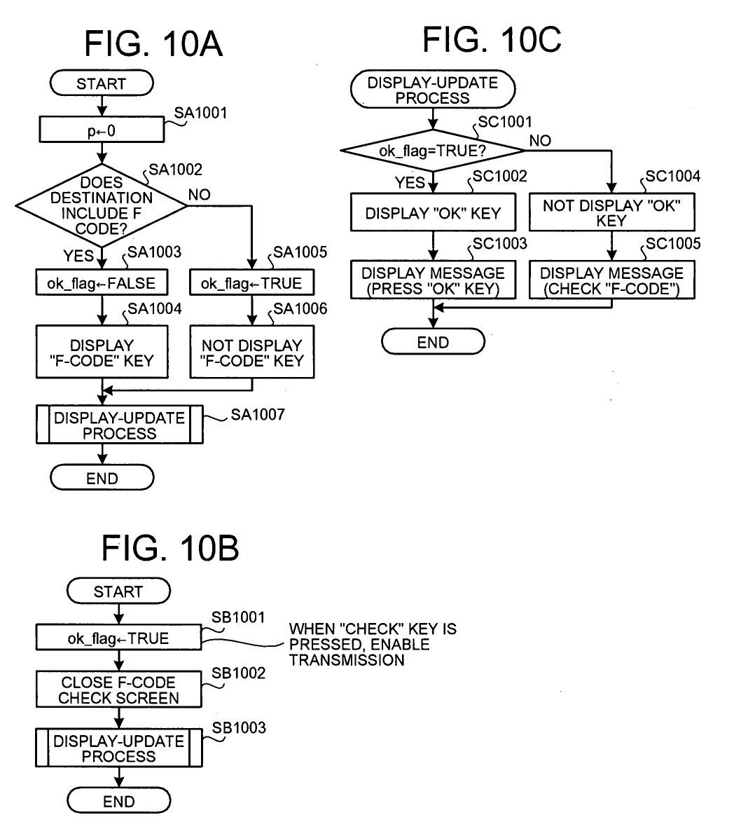

FIG. 13 is a schematic diagram for explaining yet another example of transition of display on the display panel 78. When the user presses the Start key to open the destination-check screen after specifying a destination group on a screen (A) of FIG. 13, not the destination group but a destination included in the destination group is displayed as shown on the destination-check screen (B). In this case, also, the user can check other destinations included in the destination group by pressing the “▾” key. The user cannot press the “OK” key until checking all the destinations.

With this, when specifying a destination group, a user can check destinations of transmission included in the destination group on the destination-check screen.

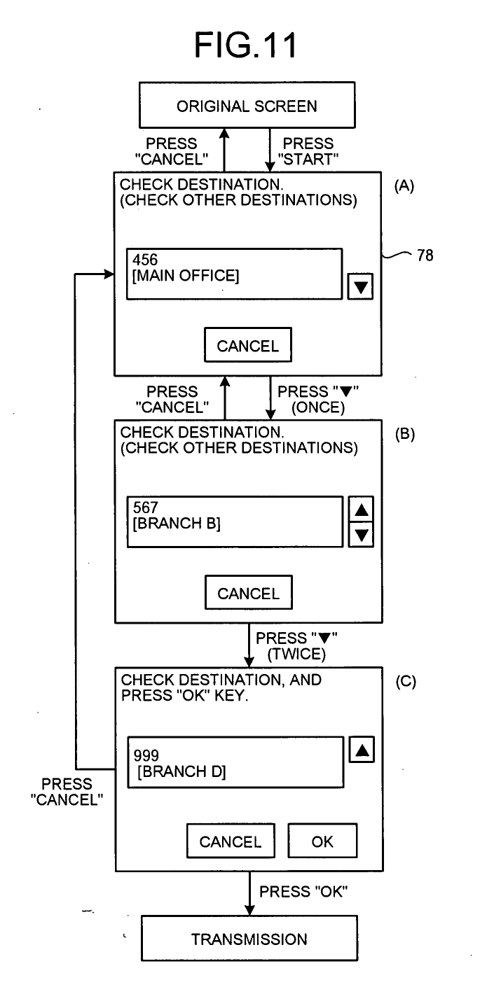

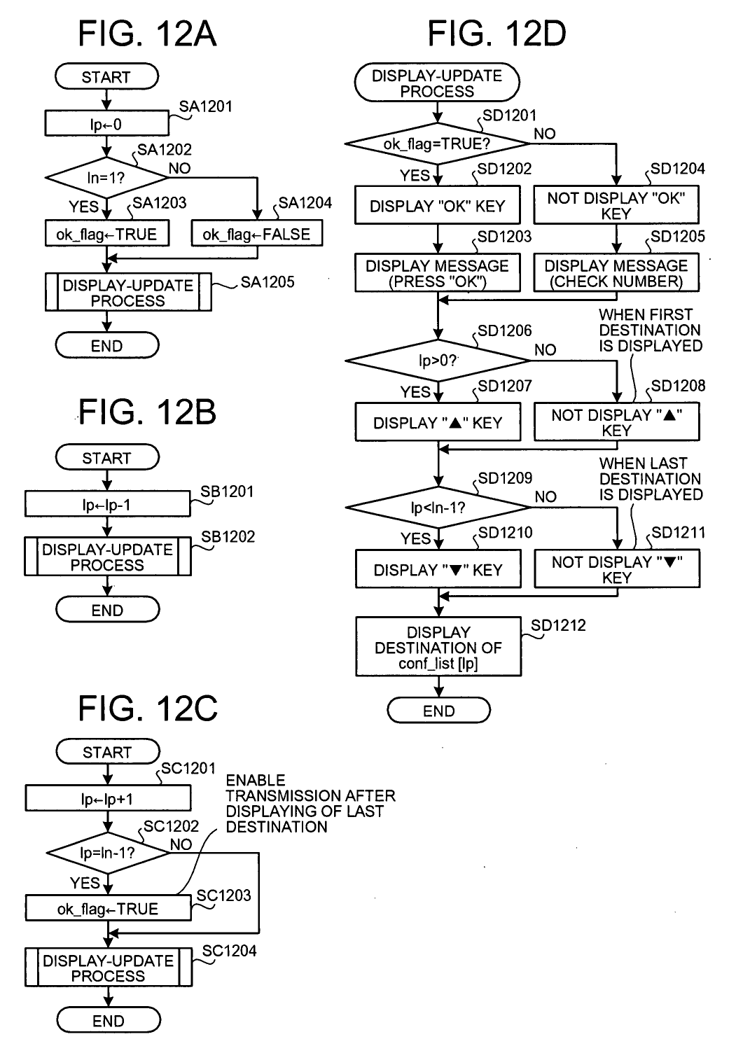

FIG. 14A is a flowchart of the process of specifying a destination performed by the MFP. FIG. 14B is an example of contents of a list of destinations to which data has been transmitted (hereinafter, “transmitted destination list”). In FIG. 14A, “sent_list” represents the transmitted destination list, “an” represents the number of destinations specified, “adr_list[0] to adr_list[an−1]” represent specified destinations, and “ok_flag” represents whether transmission can be started.

After “ok_flag-FALSE” is set (step S1401) and a counter i is initialized (step S1402), the counter i and an−1 representing the number of the last specified destination are compared (step S1403). When the counter i is equal to or less than an−1 (Yes at step S1403), it is determined whether the destination “adr_list[i]” is present in the transmitted destination list “sent_list”. If not (No at step S1404), “ok_flag=TRUE” is set (step S1405).

Then, the destination “adr_list[i]” is added to the transmitted destination list “sent_list” (step S1406), and the counter i is incremented by 1 (step S1407). This process is repeated until the counter i exceeds an−1. When the counter i exceeds an−1 (No at step S1403), it is determined whether “ok_flag=TRUE” (step S1408) is ON. If “ok_flag=TRUE” is ON (Yes at step S1408), the destination-check screen is opened (step S1409). If not (No at step S1408), transmission is started (step S1410).

The process explained above, the variable-length transmitted destination list stores therein destinations to which transmission has been made. The destination-check screen is displayed only when a user specifies a destination that is not listed in the transmitted destination list. That is, when a destination to which transmission has been made is specified, transmission (document reading and communication) is started without display of the destination-check screen.

With this, because the possibility of erroneous transmission is low when data is transmitted to a destination to which transmission has been made, a user is not required to check the destination. This improves operability for a user to, for example, repeatedly specify the same address.

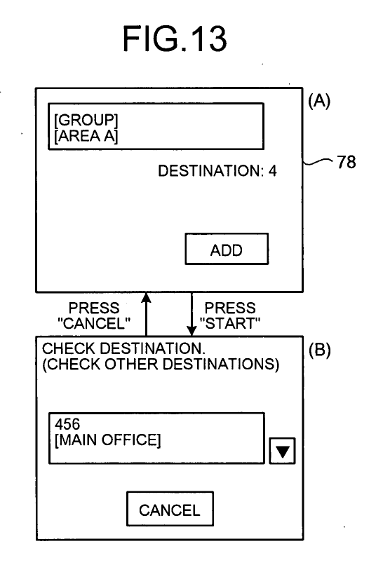

FIG. 15 is a flowchart of the process of specifying a destination performed by the MFP. In FIG. 15, “sent_list” represents the transmitted destination list, “an” represents the number of destinations specified, “adr_list[0] to adr_list[an−1]” represent specified destinations, “ok_flag” represents whether transmission can be started, “ln” represent the number of destinations displayed on the destination-check screen, and “conf_list[0] to conf_list[ln−1]” represents destinations displayed on the destination-check screen.

This process is basically similar to that previously described in connection with FIG. 14, except that a destination not listed in the transmitted destination list is displayed on the destination-check screen. That is, after “ok_flag=FALSE” is set (step S1501) and ln and i are initialized (steps S1502 and S1503), i and an−1 are compared (step S1503). When i is equal to or less than an−1 (Yes at step S1503), it is determined whether “adr_list[i]” is present in “sent_list” (step S1505). If not (No at step S1505), “ok_flag=FALSE” is set (step S1506), and “adr_list[i]” is set at “conf_list[ln]” (step S1507). Then, ln is incremented by 1 (step S1508), and “adr_list[i]” is added to “sent_list” (step S1509). After i is incremented by 1 (step S1510), this process is repeated until i exceeds an−1 (No at step S1504). Then, when “ok_flag=TRUE” is ON (Yes at step S1511), the destination-check screen is opened (step S1512). Otherwise (No at step S1511), transmission is started (step S1513).

In the process explained above, only the destination not listed in the transmitted destination list is displayed on the destination-check screen. With this, when destinations include the one to which transmission has been made and a new destination, only the new destination is displayed on destination-check screen. This facilitates destination check.

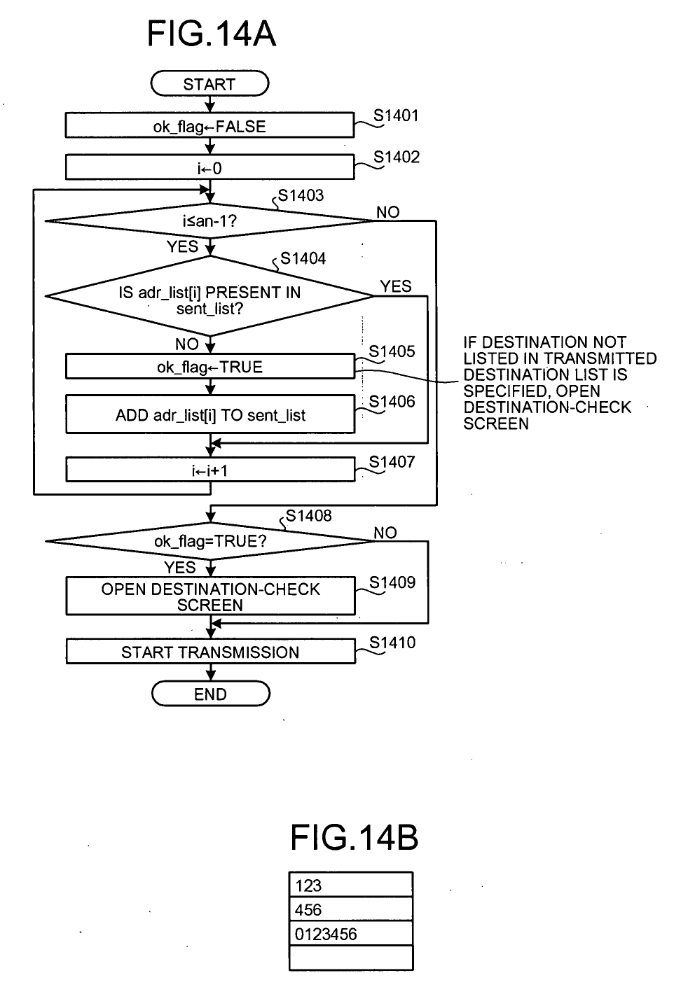

FIG. 16 is a schematic diagram for explaining an example of transition of display on the display panel 78 for user management. As shown on a screen (A) of FIG. 16, when a function (copy, fax, etc.) is used, the user is required to enter a user name and a password for log-in. Also, as depicted in a user management table, an available function is set for each user. In the example of FIG. 16, a user with a user name “Suzuki” can use the fax function upon being logged in as shown on screens (B1) and (C1), while a user with a user name “Sato” cannot use the fax function when logged in because the fax function is not available for the user “Sato” as shown on screens (B2) and (C2).

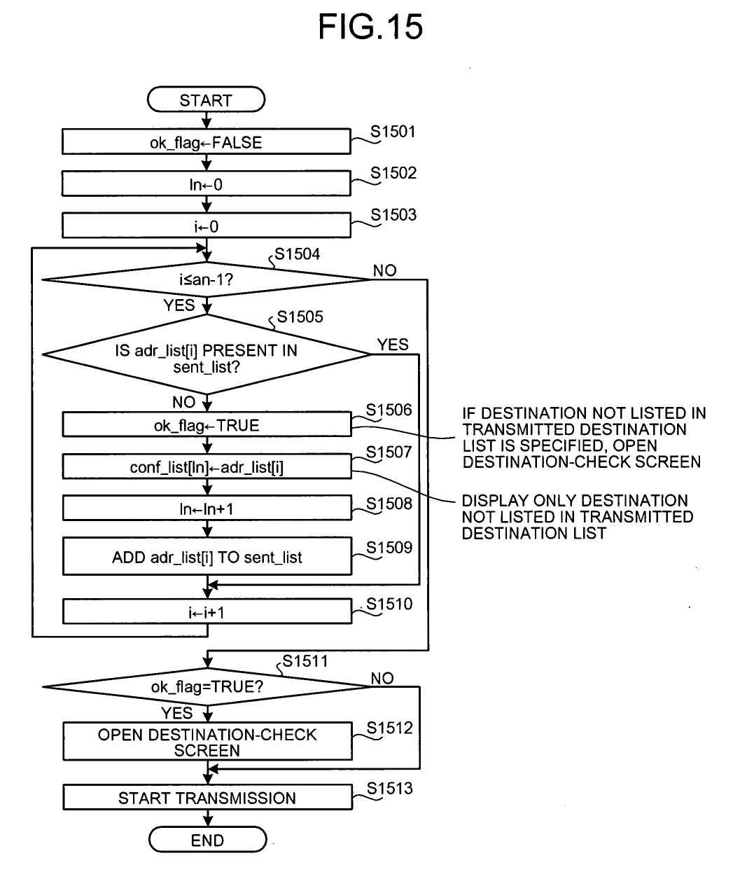

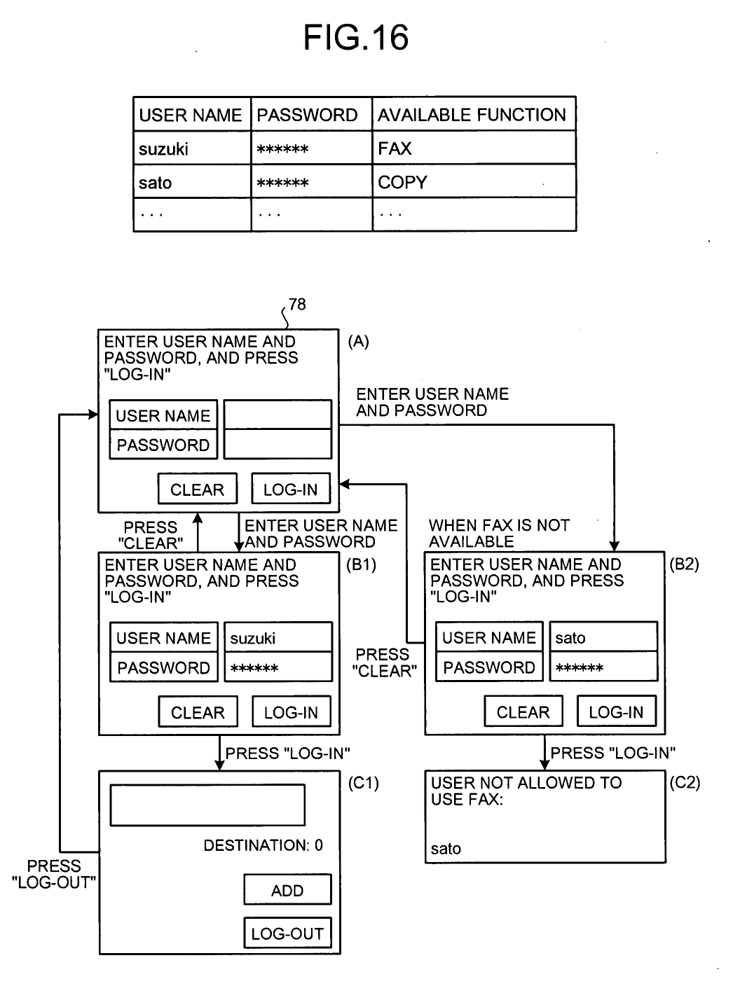

FIG. 17A is a flowchart of the process of specifying a destination performed by the MFP. FIG. 17B is an example of contents of the user management table. The process and parameters used in FIG. 17A are basically similar to those previously described in connection with FIG. 15, except that, as shown in the user management table of FIG. 17B, the transmitted destination list “sent_list” is stored for each user, and that checking whether a destination is present in the transmitted destination list and adding the destination to the list are preformed correspondingly to a log-in user.

That is, after “ok_flag=FALSE” is set and ln and i are initialized (steps S1701 to S1703), i and an−1 are compared (step S1704). When i is equal to or less than an−1 (Yes at step S1704), it is determined whether “adr_list[i]” is present in “sent_list” for a log-in user (step S1705). If “adr_list[i]” is not present in “sent_list” for the log-in user (No at step S1705), “ok_flag=TRUE” is set, and “adr_list[i]” is set at “conf_list [ln]” (steps S1706 and S1707). Then, ln is incremented by 1 (step S1708), and “adr_list[i]” is added to “sent_list” for the log-in user (step S1709). After i is incremented by 1 (step S1710), this process is repeated until i exceeds an−1 (No at step S1704). Then, when “ok_flag=TRUE” is ON (Yes at step S1711), the destination-check screen is opened (step S1712). Otherwise (No at step S1711), transmission is started (step S1713).

The process of FIG. 17A is different from that of FIG. 14 in that the destination that is not listed in the transmitted destination list is displayed on the destination-check screen. It is assumed herein that a user can use the fax function by logging in with his/her user name. The process of FIG. 17A is different from that of FIG. 15 only in that the transmitted destination list is stored for each user.

With this, even when a user specifies a destination to which transmission has been made by other users, the user checks the destination unless he/she has transmitted data to the destination. Therefore, the destination-check screen is displayed so that a user can check the destination(s) if necessary.

Also, when a destination registered in the directory has been changed, if a user not knowing that change specifies the destination, there is a high possibility of erroneous transmission. In this case, when the user specifies the destination first time after the change, the destination is regarded as “a destination not in the transmitted destination list” even if the user has specified the destination before the change. Thus, the user is rendered to check the destination.

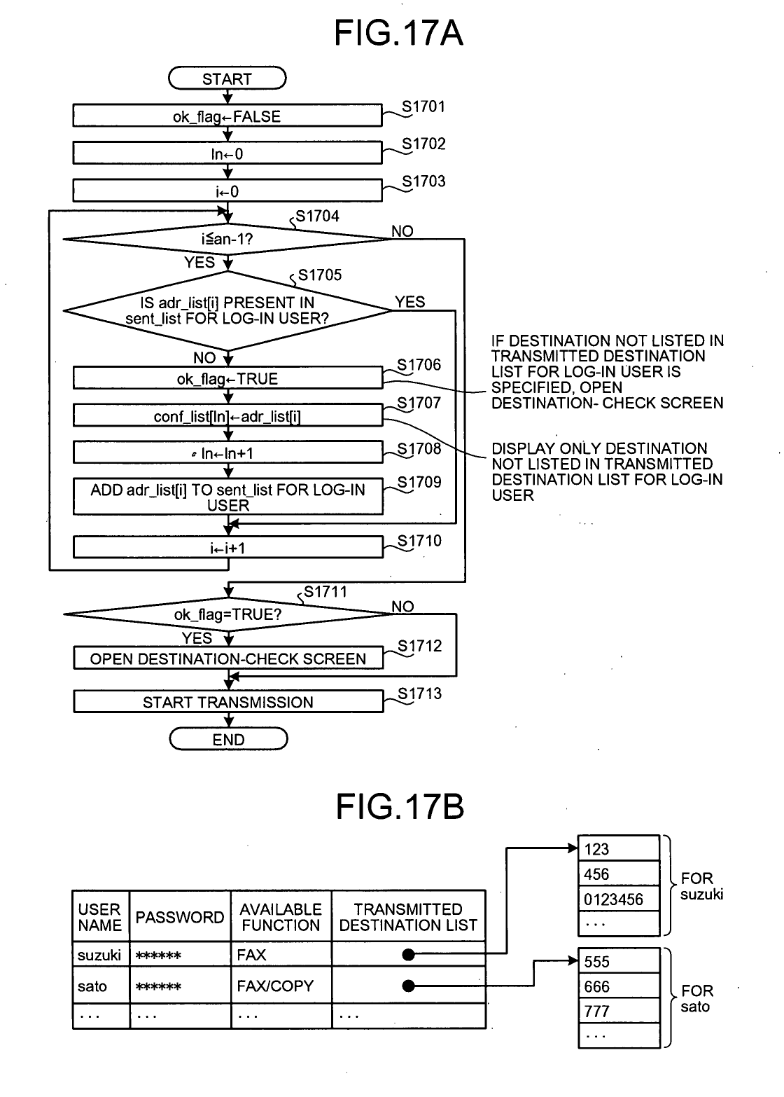

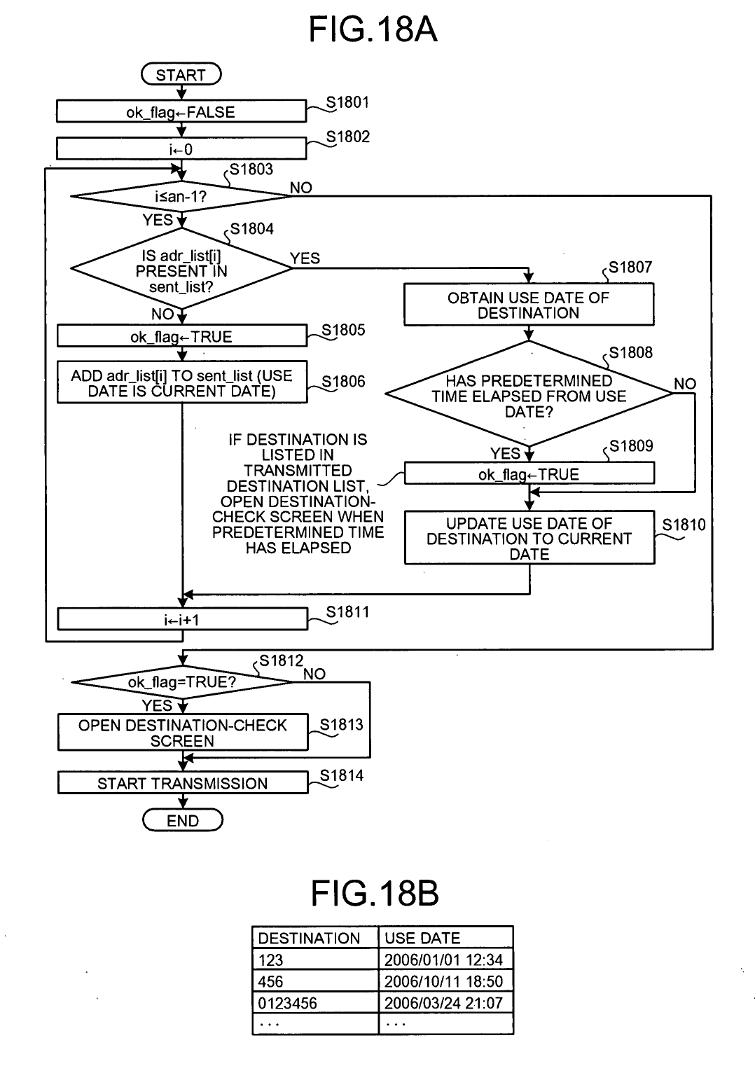

FIG. 18A is a flowchart of the process of specifying a destination performed by the MFP. FIG. 18B is another example of contents of the transmitted destination list. In FIG. 18A, “sent_list” represents the transmitted destination list, “an” represents the number of destinations specified, “adr_list[0] to adr_list[an−1]” represent specified destinations, and “ok_flag” represents whether transmission can be started.

In the process of FIG. 18A, use date (the latest date and time when transmission was made to that destination) is stored for each destination in the transmitted destination list. Even when the specified destination is listed in the transmitted destination list, if a predetermined time has elapsed from the use date until the current date, i.e., if no transmission has been performed to that destination for the predetermined time, the destination is regarded as a destination to which transmission has not been made, and is to be checked.

After “ok_flag=FALSE” is set (step S1801) and i is initialized (step S1802), i and an−1 are compared (step S1803). When i is equal to or less than an−1 (Yes at step S1803), it is determined whether “adr_list[i]” is present in “sent_list” (step S1804). If not (No at step S1804), “ok_flag=TRUE” is set (step S1805), and “adr_list[i]” is added to “sent_list” (step S1806). At this point, the use date is set at the current date.

On the other hand, when “adr_list[i]” is present in “sent_list” (Yes at step S1804), the use date of the destination on “sent_list” is obtained (step S1807). If the use date is earlier than the current date by the predetermined time, i.e., if predetermined time has elapsed from the use date until the current date (Yes at step S1808), “ok_flag=TRUE” is set (step S1809). Then, the use date of that destination on “sent_list” is updated to the current date (step S1810). After i is incremented by 1 (step S1811), this process is repeated until i exceeds an−1 (No at step S1803).

When i exceeds an−1 (No at step S1803) and “ok_flag=TRUE” is ON (Yes at step S1812), the destination-check screen is opened (step S1813). Otherwise (No at step S1812), transmission is started (step S1814).

A computer program can be executed on a computer to implement the same function or process as described above. Such a computer program can be provided as being stored in a computer-readable recording medium, i.e., a storage medium. In this case, a central processing unit (CPU) or micro processing unit (MPU) of the communication apparatus reads the computer program from the storage medium, and executes it.

Examples of the storage medium for use in providing the computer program includes flexible disk (FD), hard disk drive (HDD), optical disk, magneto-optical disk, compact-disk read-only memory (CD-ROM), compact-disk recordable (CD-R), compact-disk rewritable (CD-RW), non-volatile memory card, and a magnetic tape.

As described above, according to the embodiment, when a destination is specified and a transmission start operation is desired to be performed, a screen for checking details of the specified destination (destination-check screen) is first displayed, and transmission is not started until a check has been successfully performed on the destination-check screen. Therefore, before transmission is actually started, the details of the destination have to be necessarily checked. With this, erroneous transmission due to erroneous destination specification can be prevented.

When destination information that cannot be displayed on one destination-check screen (such information includes destinations themselves and various information associated with the destinations) is present, the destination information that cannot be displayed first is also displayed through a scroll operation or another screen display. Therefore, even destination information that cannot be displayed on one screen is present, that destination information can be checked, thereby preventing erroneous transmission due to specifying wrong destination information.

When destination information that cannot be displayed on one destination-check screen is present, a check OK operation is prevented from being performed until the destination information that cannot be displayed first is checked. Therefore, the destination information can be reliably checked, thereby preventing erroneous transmission due to specifying wrong destination information.

If all digits cannot be displayed on one destination-check screen, the portion that cannot be displayed is also displayed through a scroll operation or the like. Therefore, even the destination with long numbers whose digits cannot be displayed on the destination-check screen at one time can be checked for all digits. Thereby the destination prevents erroneous transmission due to wrong-specifying long destination.

If all digits cannot be displayed on one destination-check screen, a check OK operation is prevented from being performed until an operation of displaying all digits is performed. Therefore, even the destination with long numbers whose digits cannot be displayed on the destination-check screen at one time can be reliably checked for all digits, thereby preventing erroneous transmission due to wrong-specifying long destination.

If additional information (for example, F code) is included in the destination on the destination-check screen, a screen for checking the additional information of the destination can be displayed, thereby preventing erroneous transmission due to specifying wrong addition information of the destination.

If additional information (e.g., F code) is included in the destination, a check OK operation is prevented from being performed until an operation of displaying the screen for checking the additional information of the destination is performed. Therefore, the additional information can be reliably checked for the destination including the additional information, thereby preventing erroneous transmission due to specifying wrong addition information of the destination.

When a plurality of destinations are specified, if a destination that cannot be displayed on one destination-check screen is present, the destination that cannot be displayed is also displayed through a scroll operation. Therefore, even when a plurality of destinations are specified, all destinations can be checked, thereby preventing erroneous transmission due to specifying a wrong destination at the time of specifying a plurality of destinations.

When a plurality of destinations are specified, if a destination that cannot be displayed on one destination-check screen is present, a check OK operation is prevented from being performed until an operation of displaying all destinations is performed. Therefore, when a plurality of destinations are specified, all destinations can be reliably checked, thereby preventing erroneous transmission due to specifying a wrong destination at the time of specifying a plurality of destinations.

When a destination group is specified, destinations included in the destination group, which are those to which transmission is to be actually made, are displayed on the destination-check screen. Therefore, the numbers of the destinations to which transmission is to be actually made can be checked, thereby preventing erroneous transmission due to specifying a wrong destination group.

A destination to which transmission has been formerly made is stored, and the destination-check screen is displayed only when a destination to which transmission has not been formerly made is specified. Therefore, when the destination to which transmission has been formerly made is specified, destination check can be omitted, thereby preventing erroneous transmission due to specifying a wrong destination and increasing operability when repeatedly specifying the same destination.

When a plurality of destinations are specified and they include a destination to which transmission has not been formerly made (non-transmission destination), only the non-transmission destination is displayed on the destination-check screen. Therefore, only the destination to be checked is displayed on the destination-check screen, and destinations not requiring check are not displayed on the destination-check screen, thereby preventing erroneous transmission due to specifying a wrong destination and minimizing a task of destination check.

Destinations to which transmission has been formerly made are stored for each user, and the destination-check screen is displayed only when a destination to which transmission has not been formerly made by the user is specified. Therefore, for each user, if the destination to which transmission has been made by the user is specified, destination check for that destination can be omitted, thereby preventing erroneous transmission due to specifying a wrong destination and, according to the use state for each user, increasing operability when repeatedly specifying the same destination by the user.

For each user, a destination to which transmission has been formerly made is stored. When a plurality of destinations are specified and they include a destination to which transmission has not been formerly made by the user (non-transmission destination), only the non-transmission destination for the user is displayed on the destination-check screen. Therefore, only the destination to be checked by the user is displayed on the destination-check screen, and destinations not requiring check are not displayed on the destination-check screen, thereby preventing erroneous transmission due to specifying a wrong destination and, according to the use state for each user, minimizing a task of destination check.

Even the destination to which transmission has been made is taken as a check target if a predetermined time has passed from the previous transmission to that destination. Therefore, it is possible to prevent erroneous transmission due to specifying a wrong destination when the destination not being used for a long time is specified, which may have a risk of a wrong destination similar to a risk occurring when a destination is specified for the first time.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication apparatus comprising:
a specifying unit that specifies a communication destination;
a display unit that displays information on the communication destination on a first check screen;
a communication control unit that issues an instruction to initiate communication with the communication destination after the information is checked on the check screen; and
a communicating unit that communicates with the communication destination in response to the instruction from the communication control unit.

2. The communication apparatus according to claim 1, wherein the display unit displays an item that allows access to information on the communication destination that is not displayed on the check screen.

3. The communication apparatus according to claim 2, wherein the communication control unit issues an instruction to initiate communication after the information displayed through the item is checked.

4. The communication apparatus according to claim 2, wherein the display unit displays a predetermined number of digits of a destination number, and, when a destination number contains digits exceeding the predetermined number, displays a key that allows display of all digits of the destination number.

5. The communication apparatus according to claim 4, wherein the communication control unit issues an instruction to initiate communication after all the digits of the destination number are checked.

6. The communication apparatus according to claim 2, wherein the display unit displays a second check screen that allows access to additional information on the communication destination.

7. The communication apparatus according to claim 6, wherein the communication control unit issues an instruction to initiate communication after the additional information is checked on the second check screen.

8. The communication apparatus according to claim 2, wherein the display unit displays a predetermined number of communication destinations, and, when the specifying unit specifies communication destinations exceeding the predetermined number, displays a key that allows display of all the communication destinations.

9. The communication apparatus according to claim 8, wherein the communication control unit issues an instruction to initiate communication after all the communication destinations are checked.

10. The communication apparatus according to claim 1, wherein
the specifying unit specifies a group of communication destinations;
the display unit displays information on each of the communication destinations in the group; and
the communication control unit issues an instruction to initiate communication with the group after the information is checked for each of the communication destinations.

11. The communication apparatus according to claim 1, further comprising a storage unit that stores therein a communication destination that the communicating unit has communicated with, wherein
the display unit displays, when the specifying unit specifies a communication destination that is not stored in the storage unit, information on the communication destination; and
the communication control unit issues an instruction to initiate communication after the information on the communication destination is checked.

12. The communication apparatus according to claim 11, wherein the display unit displays, when the specifying unit specifies a plurality of communication destinations including a communication destination that is not stored in the storage unit, information on only the communication destination that is not stored in the storage unit.

13. The communication apparatus according to claim 11, wherein
the storage unit stores therein a communication destination that the communicating unit has communicated with for each user;
the display unit displays, when a user specifies through the specifying unit a communication destination that is not stored in the storage unit for the user, information on the communication destination; and
the communication control unit issues an instruction to initiate communication after the information on the communication destination is checked.

14. The communication apparatus according to claim 13, wherein the display unit displays, when a user specifies through the specifying unit a plurality of communication destinations including a communication destination that is not stored in the storage unit for the user, information on only the communication destination that is not stored in the storage unit for the user.

15. The communication apparatus according to claim 11, wherein
the storage unit stores therein a communication destination that the communicating unit has performed communication with in association with date and time of the communication, and
a communication destination is regarded as a communication destination that the communicating unit has not performed communication with when a predetermined time has elapsed from date and time associated with the communication destination.
